(19) United States
(12) Patent Application Publication
(10) Pub. No.: US 2019/0373292 A1
(43) Pub. Date: Dec. 5, 2019

(54) IN-LOOP BILATERAL FILTER TYPE DECISION BASED ON BLOCK INFORMATION

(71) Applicant: QUALCOMM Incorporated, San Diego, CA (US)

(72) Inventors: Akshay Gadde, Fremont, CA (US); Vadim Seregin, San Diego, CA (US); Wei-Jung Chien, San Diego, CA (US); Marta Karczewicz, San Diego, CA (US)

(21) Appl. No.: 16/427,042

(22) Filed: May 30, 2019

Related U.S. Application Data
(60) Provisional application No. 62/679,500, filed on Jun. 1, 2018.

(51) Int. Cl. H04N 19/86; H04N 19/44

(52) U.S. Cl. CPC H04N 19/86; H04N 19/44

(57) ABSTRACT

A video decoder is configured to determine, for a first block of video data, that a filter process using a first filter for a sub-block of the first block uses pixel values from neighboring sub-blocks of the sub-block of the first block; determine a number of sub-blocks in the first block of video data; and in response to the number of sub-blocks in the first block of video data being equal to one, filter the sub-block using the first filter.

This application claims the benefit of U.S. Provisional Patent Application 62/679,500 filed Jun. 1, 2018, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the recently finalized High Efficiency Video Coding (HEVC) standard, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques related to a filtering method which may be used in a post-processing stage, as part of in-loop coding, or in the prediction stage of a video encoder and/or decoder. The techniques of this disclosure may be implemented into existing video codecs, such as HEVC (High Efficiency Video Coding) codecs or be an efficient coding tool for a future video coding standard, such as the H.266 standard presently under development, which is also referred to as the Versatile Video Coding (VVC) standard. In particular, the techniques of this disclosure may be used in conjunction with a bilateral filter and/or a non-local division-free bilateral filter (NLBF).

According to one example, a method of decoding video data includes determining, for a first block of video data, that a filter process using a first filter for a sub-block of the first block uses pixel values from neighboring sub-blocks of the sub-block of the first block; determining a number of sub-blocks in the first block of video data; and in response to the number of sub-blocks in the first block of video data being equal to one, filtering the sub-block using the first filter.

A device for decoding video data includes a memory configured to store video data and one or more processors configured to determine, for a first block of video data, that a filter process using a first filter for a sub-block of the first block uses pixel values from neighboring sub-blocks of the sub-block of the first block; determine a number of sub-blocks in the first block of video data; and in response to the number of sub-blocks in the first block of video data being equal to one, filter the sub-block using the first filter.

According to another example, an apparatus includes means for determining, for a first block of video data, that a filter process using a first filter for a sub-block of the first block uses pixel values from neighboring sub-blocks of the sub-block of the first block; means for determining a number of sub-blocks in the first block of video data; and means for filtering the sub-block using the first filter in response to the number of sub-blocks in the first block of video data being equal to one.

According to another example, a computer-readable storage medium storing instructions that when executed by one or more processors cause the one or more processors to determine, for a first block of video data, that a filter process using a first filter for a sub-block of the first block uses pixel values from neighboring sub-blocks of the sub-block of the first block; determine a number of sub-blocks in the first block of video data; and in response to the number of sub-blocks in the first block of video data being equal to one, filter the sub-block using the first filter.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIGS. 2A and 2B are conceptual diagrams illustrating an example quadtree binary tree (QTBT) structure, and a corresponding coding tree unit (CTU).

FIG. 3 shows an example block diagram of an HEVC decoder.

FIGS. 4A-4D show four 1-D directional patterns for edge offset (EO) sample classification.

FIG. 5 shows an example of one sample and its neighboring four samples utilized in a bilateral filtering process.

FIG. 6 shows another example of one sample and its neighboring four samples utilized in a bilateral filtering process.

FIG. 7 shows examples of 3×3 windows for performing non-local division-free bilateral filter (NLBF).

FIG. 8 shows an example of reconstructed pixels from neighboring blocks for performing NLBF on boundary pixels.

FIG. 9 shows an example of a CU with four corresponding TUs.

FIG. 10 is a block diagram illustrating an example video encoder that may implement the techniques described in this disclosure.

FIG. 11 is a block diagram illustrating an example video decoder that may implement the techniques described in this disclosure.

FIG. 12 shows an example implementation of a filter unit for performing the techniques of this disclosure.

FIG. 13 is a flowchart illustrating an example decoding process in accordance with techniques of this disclosure.

### DETAILED DESCRIPTION

This disclosure describes techniques related to a filtering method which may be used in a post-processing stage, as part of in-loop coding, or in the prediction stage of a video encoder and/or decoder. The techniques of this disclosure may be implemented into existing video codecs, such as HEVC (High Efficiency Video Coding) codecs or be an efficient coding tool for a future video coding standard, such as the H.266 standard presently under development, which is also referred to as the Versatile Video Coding (VVC) standard.

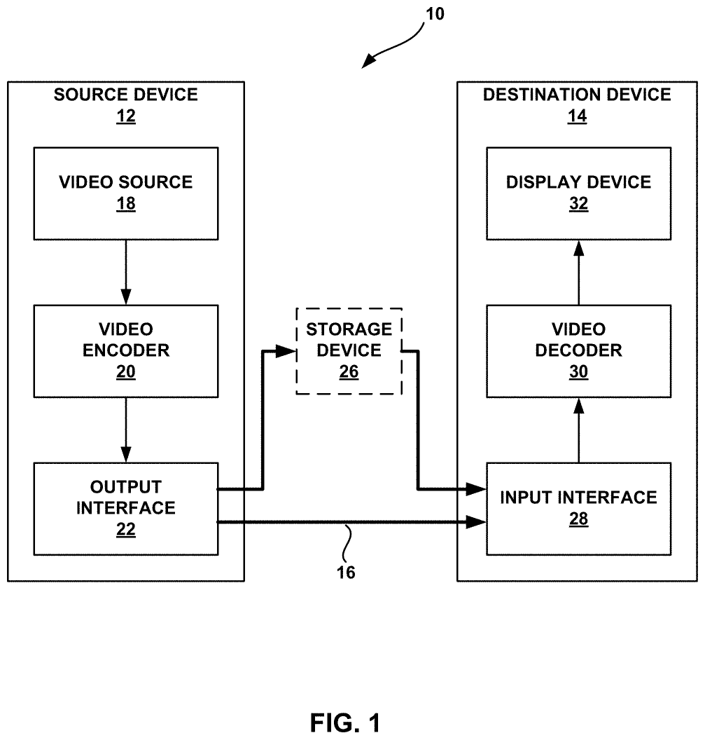

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may be any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may include one or more of any type of medium or device capable of moving the encoded video data from source device 12 to destination device 14. In one example, link 16 may include one or more communication mediums to enable source device 12 to transmit encoded video data directly to destination device 14 in real-time. The encoded video data may be modulated according to a communication standard, such as a wireless communication protocol, and transmitted to destination device 14. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user and may be any of a variety of display devices such as a liquid crystal display (LCD), a plasma display, an organic light emitting diode (OLED) display, or another type of display device.

Video encoder 20 and video decoder 30 may operate according to a video coding standard, such as ITU-T H.265, also referred to as High Efficiency Video Coding (HEVC) or extensions thereto, such as the multi-view and/or scalable video coding extensions. Alternatively, video encoder 20 and video decoder 30 may operate according to other proprietary or industry standards, such as the Joint Exploration Test Model (JEM) or ITU-T H.266, also referred to as Versatile Video Coding (VVC). A recent draft of the VVC standard is described in Bross, et al. “Versatile Video Coding (Draft 5),” Joint Video Experts Team (JVET) of ITU-T SG 16 WP 3 and ISO/IEC JTC 1/SC 29/WG 11, 14^{th} Meeting: Geneva, CH, 19-27 Mar. 2019, JVET-N1001-v3 (hereinafter “VVC Draft 5”). The techniques of this disclosure, however, are not limited to any particular coding standard.

Video encoder 20 and video decoder 30 may also operate according to other proprietary or industry standards, such as the ITU-T H.264 standard, alternatively referred to as ISO/IEC MPEG-4, Part 10, Advanced Video Coding (AVC), or extensions of such standards, such as the Scalable Video Coding (SVC) and Multi-view Video Coding (MVC) extensions. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, and ISO/IEC MPEG-4 Visual.

ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a collaborative effort known as the Joint Video Exploration Team (JVET) to evaluate compression technology designs proposed by their experts in this area. The JVET first met during 19-21 Oct. 2015. One version of applicable reference software, i.e., Joint Exploration Model 7 (JEM 7) can be downloaded from: https://jvet.hhi.fraunhofer.de/svn/svn_HMJEMSoftware/tags/HM-16.6-JEM-7.0/. An algorithm description of Joint Exploration Test Model 6 (JEM6) may also be referred to as JVET-G1011.

Techniques of this disclosure may utilize HEVC terminology for ease of explanation. It should not be assumed, however, that the techniques of this disclosure are limited to HEVC, and in fact, it is explicitly contemplated that the techniques of this disclosure may be implemented in successor standards to HEVC such as VVC and extensions of VVC.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In HEVC and other video coding specifications, a video sequence typically includes a series of pictures. Pictures may also be referred to as “frames.” In one example approach, a picture may include three sample arrays, denoted SL, SCb, and Scr. In such an example approach, SL is a two-dimensional array (i.e., a block) of luma samples. SCb is a two-dimensional array of Cb chrominance samples. Scr is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may include a coding tree block of luma samples, two corresponding coding tree blocks of chroma samples, and syntax structures used to code the samples of the coding tree blocks. In monochrome pictures or pictures having three separate color planes, a CTU may include a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

To generate a coded CTU, video encoder 20 may recursively perform quad-tree partitioning on the coding tree blocks of a CTU to divide the coding tree blocks into coding blocks, hence the name “coding tree units.” A coding block may be an N×N block of samples. A CU may include a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may include a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may include a prediction block of luma samples, two corresponding prediction blocks of chroma samples, and syntax structures used to predict the prediction blocks. In monochrome pictures or pictures having three separate color planes, a PU may include a single prediction block and syntax structures used to predict the prediction block. Video encoder 20 may generate predictive luma, Cb, and Cr blocks for luma, Cb, and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate the predictive blocks of a PU, video encoder 20 may generate the predictive blocks of the PU based on decoded samples of one or more pictures other than the picture associated with the PU.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb, and Cr residual blocks of a CU into one or more luma, Cb, and Cr transform blocks. A transform block is a rectangular (e.g., square or non-square) block of samples on which the same transform is applied. A transform unit (TU) of a CU may include a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

The above block structure with CTUs, CUs, PUs, and TUs generally describes the block structure used in HEVC. Other video coding standards, however, may use different block structures. As one example, although HEVC allows PUs and TUs to have different sizes or shapes, other video coding standards may require predictive blocks and transform blocks to have a same size. The techniques of this disclosure are not limited to the block structure of HEVC and may be compatible with other block structures.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. The bitstream may include a sequence of Network Abstraction Layer (NAL) units. A NAL unit is a syntax structure containing an indication of the type of data in the NAL unit and bytes containing that data in the form of a raw byte sequence payload (RB SP) interspersed as necessary with emulation prevention bits. Each of the NAL units includes a NAL unit header and encapsulates a RBSP. The NAL unit header may include a syntax element that indicates a NAL unit type code. The NAL unit type code specified by the NAL unit header of a NAL unit indicates the type of the NAL unit. A RB SP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a PPS, a second type of NAL unit may encapsulate an RBSP for a coded slice, a third type of NAL unit may encapsulate an RBSP for SEI messages, and so on. NAL units that encapsulate RBSPs for video coding data (as opposed to RBSPs for parameter sets and SEI messages) may be referred to as VCL NAL units.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. In addition, video decoder 30 may inverse quantize coefficient blocks associated with TUs of a current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

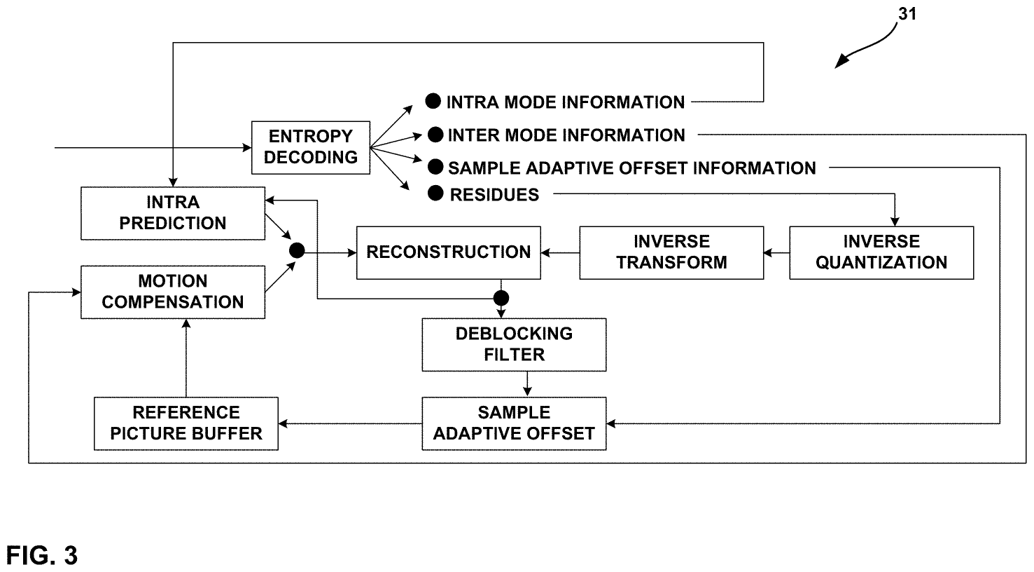

Aspects of HEVC and JEM techniques will now be discussed. FIG. 3 shows an example block diagram of an HEVC decoder. The video decoder shown in FIG. 3 may correspond to video decoder 30, for example. The following is a description of the quad-tree structure, followed by the in-loop filters employed by HEVC.

HEVC utilizes a quadtree structure for partitioning blocks. In HEVC, the largest coding unit in a slice is called a coding tree block (CTB) or coding tree unit (CTU). A CTB contains a quad-tree the nodes of which are coding units. The blocks specified as luma and chroma CTBs can be directly used as CBs or can be further partitioned into multiple CBs. Partitioning is achieved using tree structures. The tree partitioning in HEVC is generally applied simultaneously to both luma and chroma, although exceptions apply when certain minimum sizes are reached for chroma.

The CTU contains a quadtree syntax that allows for splitting the CBs to a selected appropriate size based on the signal characteristics of the region that is covered by the CTB. The quadtree splitting process can be iterated until the size for a luma CB reaches a minimum allowed luma CB size that is selected by the encoder (e.g., video encoder 20) using syntax in the SPS and is always 8×8 or larger (in units of luma samples).

The boundaries of the picture are defined in units of the minimum allowed luma CB size. As a result, at the right and bottom edges of the picture, some CTUs may cover regions that are partly outside the boundaries of the picture. This condition is detected by the decoder (e.g., video decoder 30), and the CTU quadtree is implicitly split as necessary to reduce the CB size to the point where the entire CB fits into the picture.

Aspects of quadtree partitioning are described in more detail in G. J. Sullivan; J.-R. Ohm; W.-J. Han; T. Wiegand (December 2012). “Overview of the High Efficiency Video Coding (HEVC) Standard.” IEEE Transactions on Circuits and Systems for Video Technology (IEEE) 22 (12). Retrieved 2012 Sep. 2014. Note that no signaling is required when the leaf nodes correspond to 8×8 CUs.

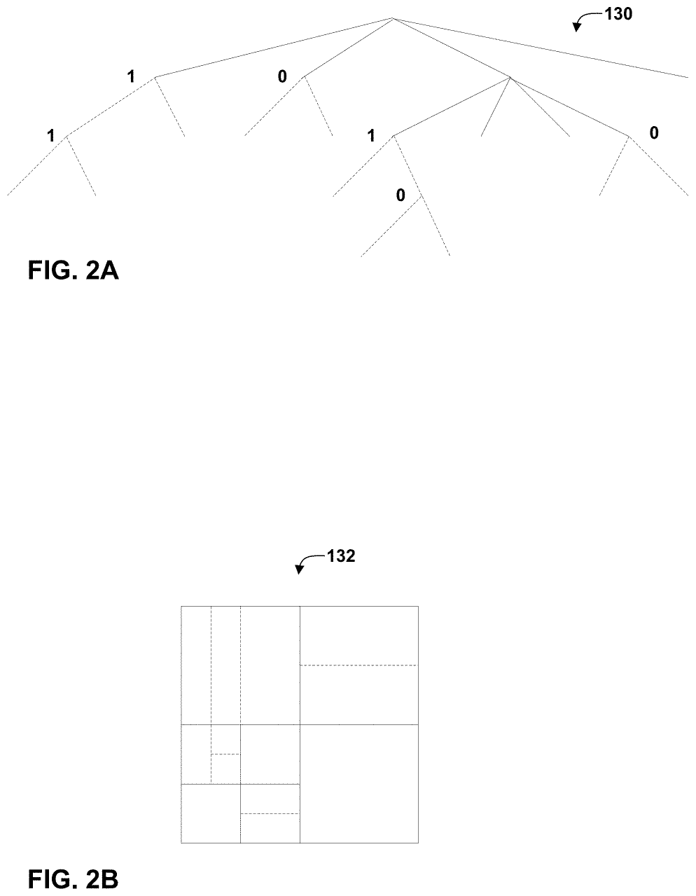

FIGS. 2A and 2B are conceptual diagram illustrating an example quadtree binary tree (QTBT) structure 130, and a corresponding coding tree unit (CTU) 132. Unlike quadtree partitioning where blocks are split into four sub-blocks, in QTBT, block may be split into two or four sub-blocks. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 20 may encode, and video decoder 30 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 20 may encode, and video decoder 30 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

HEVC employs two in-loop filters, including a de-blocking filter (DBF) and a sample adaptive offset (SAO) filter. Additional details regarding HEVC decoding and SAO are described in C. Fu, E. Alshina, A. Alshina, Y. Huang, C. Chen, Chia. Tsai, C. Hsu, S. Lei, J. Park, W. Han, “Sample adaptive offset in the HEVC standard,” IEEE Trans. Circuits Syst. Video Technol., 22(12): 1755-1764 (2012).

As illustrated in FIG. 3, the input to a DBF may be the reconstructed image after intra or inter prediction, as shown with the output from the reconstruction block. The DBF performs detection of the artifacts at the coded block boundaries and attenuates the artifacts by applying a selected filter. Compared to the H.264/AVC deblocking filter, the HEVC deblocking filter has lower computational complexity and better parallel processing capabilities while still achieving significant reduction of the visual artifacts. For additional examples, see A. Norkin, G. Bjontegaard, A. Fuldseth, M. Narroschke, M. Ikeda, K. Andersson, Minhua Zhou, G. Van der Auwera, “HEVC Deblocking Filter,” IEEE Trans. Circuits Syst. Video Technol., 22(12): 1746-1754 (2012).

In HEVC, the deblocking filter decisions are made separately for each boundary of a four-sample length that lies on the grid dividing the picture into blocks of 8×8 samples. Deblocking is performed on a block boundary if the following conditions are true: (1) the block boundary is a prediction unit (PU) or transform unit (TU) boundary; (2) the boundary strength (Bs), as defined in Table 1 below, is greater than zero; (3) the variation of signal, as defined in Equation (1) below, on both sides of a block boundary is below a specified threshold.

TABLE 1
Boundary strength (Bs) values for boundaries
between two neighboring luma blocks

| Conditions | Bs |
|---|---|
| At least one of the blocks is Intra | 2 |
| At least one of the blocks has non- | 1 |
| zero coded residual coefficient and | |
| boundary is a transform boundary | |
| Absolute differences between | 1 |
| corresponding spatial motion vector | |
| components of the two blocks are >=1 | |
| in units of integer pixels | |
| Motion-compensated prediction for | 1 |
| the two blocks refers to different | |
| reference pictures or the number | |
| of motion vectors is different for | |
| the two blocks | |
| Otherwise | 0 |

If Bs>0 for a luma block boundary, then the deblocking filtering is applied to that boundary the following condition holds:

|p_{2,0}−2p_{1,0}+p_{0,0}|+|p_{2,3}−2p_{1,3}+p_{0,3}|+|q_{2,0}−2q_{1,0}+q_{0,0}|+q_{2,3}−2q_{1,3}+q_{0,3}|<β,

where p and q are luma sample values at the boundary and β is a threshold.

HEVC allows for two types of luma deblocking filters, namely: (i) normal filter, and (ii) strong filter. The choice of deblocking filter depends on whether particular signal variation terms are less than certain thresholds (see “HEVC Deblocking Filter” by Norkin et al (2012) cited above for details). Although the filtering decisions are based only on the two rows (or columns) of a four pixel long vertical (or horizontal, as the case may be) boundary, the filter is applied to every row (or column, as the case may be) in the boundary. The number of pixels used in the filtering process and the number of pixels that may be modified with each type of filtering is summarized in Table 2 below.

TABLE 2
Number of pixels used/modified
per boundary in HEVC deblocking

| | Pixels used | Pixels modified |
|---|---|---|
| | (on either side of boundary) | (on either side of boundary) |
| Normal filter | 3 or 2 | 2 or 1 |
| Strong filter | 4 | 3 |

Chroma deblocking (i.e., deblocking filtering performed on chroma components) is performed only when Bs equals two (2). In HEVC, only one type of chroma deblocking filter is used. The chroma deblocking filter uses pixels p₀, p₁, q₀, q₁ and may modify pixels p₀ and q₀ in each row (the second subscript indicating the row index is omitted in the above description for brevity, because the filter is applied to every row). In JEM, deblocking is performed at the CU level. The size of CUs on either side of a boundary can be larger than 8×8. The minimum CU size is in JEM is 4×4. Therefore, deblocking filter may also be applied to boundaries of 4×4 blocks.

The input to an SAO filter may be the reconstructed block after applying the deblocking filter, as shown with the output from the deblocking filter in FIG. 2. A video coder may apply an SAO filter to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC, the region (the unit for SAO parameters signaling) is defined to be a CTU.

Two SAO types that can satisfy the requirement of being low complexity were adopted in HEVC. Those two types are edge offset (EO) and band offset (BO) SAO, which are discussed in further detail below. Video encoder 20 and video decoders 30 or 31 may code an index of an SAO type. For EO, the sample classification is based on comparison between current samples and neighboring samples according to 1-D directional patterns: horizontal, vertical, 135° diagonal, and 45° diagonal.

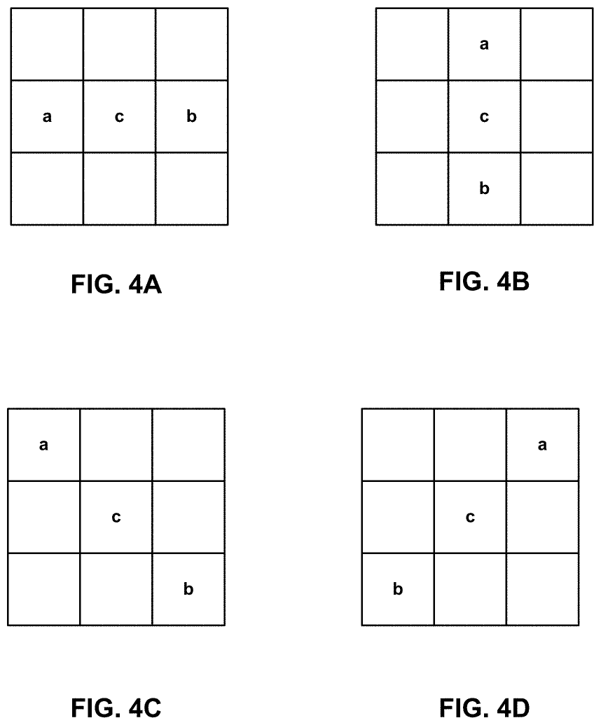

FIGS. 4A-4D show four 1-D directional patterns for EO sample classification: horizontal (FIG. 4A, EO class=0), vertical (FIG. 4B, EO class=1), 135° diagonal (FIG. 4C, EO class=2), and 45° diagonal (FIG. 4D, EO class=3). In the example of FIGS. 4A-4C, “c” represents the sample being classified, and “a” and “b” represent samples being compared to sample c. Additional details related to SAO are described in C. Fu, E. Alshina, A. Alshin, Y. Huang, C. Chen, Chia. Tsai, C. Hsu, S. Lei, J. Park, W. Han, “Sample adaptive offset in the HEVC standard,” IEEE Trans. Circuits Syst. Video Technol., 22(12): 1755-1764 (2012).

According to the selected EO pattern, five categories denoted by edgeIdx in Table 3 are further defined. For edgeIdx equal to 0-3, the magnitude of an offset may be signaled while the sign flag is implicitly coded, i.e., negative offset for edgeIdx equal to 0 or 1 and positive offset for edgeIdx equal to 2 or 3. For edgeIdx equal to 4, the offset is always set to 0 which means no operation is required for this case.

TABLE 3
classification for EO

| Category | |
|---|---|
| (edgeIdx) | Condition |
| 0 | c < a && c < b |
| 1 | (c < a && c == b) ∥ (c == a && c < b) |
| 2 | (c > a && c == b) ∥ (c == a && c > b) |
| 3 | c > a && c > b |
| 4 | None of the above |

For BO, the sample classification is based on sample values. Each color component may have its own SAO parameters for classification for BO type SAO filtering. BO implies one offset is added to all samples of the same band. The sample value range is equally divided into 32 bands. For 8-bit samples ranging from 0 to 255, the width of a band is 8, and sample values from 8k to 8k+7 belong to band k, where k ranges from 0 to 31. One offset is added to all samples of the same band. The average difference between the original samples and reconstructed samples in a band (i.e., offset of a band) is signaled to the decoder (e.g., video decoder 30 or 31). There is no constraint on offset signs. Only offsets of four (4) consecutive bands and the starting band position are signaled to the decoder (e.g., video decoder 30 or 31).

To reduce the amount side information that needs to be signalled, multiple CTUs can be merged together to share SAO parameters. For example, parameters for a current CTU may be copied from the parameters of the CTU above by setting a value for the syntax element sao_merge_up_flag equal to 1 or may be copied from a left CTU by setting a value for the syntax element sao_merge left flag equal to 1.

In addition to the modified DB and HEVC SAO methods, JEM includes another filtering method, called Geometry transformation-based Adaptive Loop Filtering (GALF), as described in M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-B0060, 2^{nd} Meeting: San Diego, USA, 20 Feb.-26 Feb. 2016 and M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-C0038, 3^{rd} Meeting: Geneva, CH, 26 May-1 Jun. 2016. Input to GALF is the reconstructed image after application of SAO. GALF aims improve the coding efficiency of ALF studied in HEVC stage by introducing several new features. ALF aims to minimize the mean square error between original samples and decoded samples by using Wiener-based adaptive filter. Samples in a picture are classified into multiple categories and the samples in each category are then filtered with their associated adaptive filter. The filter coefficients may be signaled or inherited from previous frames to optimize the trade-off between the mean square error and the overhead.

GALF introduces geometric transformations, such as rotation, diagonal flip, and vertical flip, to be applied to the samples in filter support region depending on the orientation of the gradient of the reconstructed samples before ALF. In GALF, the classification is modified by taking into consideration the diagonal gradients. Each 2×2 block is categorized into one out of 25 classes based on its directionality and quantized value of activity computed using local gradients.

One example of Bilateral filtering is described in C. Tomasi and R. Manduchi, “Bilateral filtering for gray and color images,” in Proc. of IEEE ICCV, Bombay, India, January 1998. Bilateral filtering was proposed to avoid undesirable over-smoothing of pixels on the edge during filtering. The main idea of bilateral filtering is to weight the neighboring pixels based on the difference between the intensity values of the current pixel (to be filtered) and the neighboring pixels. The neighboring pixels with luminance/chrominance values similar to the luminance/chrominance value of the pixel to be filtered are given a higher weight. A sample located at (i, j), will be filtered using its neighboring sample (k, l). The weight ω(i, j, k, l) is the weight assigned for sample (k, l) to filter the sample (i, j), and is defined as:

$$ω ( i , j , k , l ) = {e}^{( - \frac{{( i - k )}^{2} + {( j - l )}^{2}}{2 {σ}_{d}^{2}} - \frac{{‖ I ( i , j ) - I ( k , l ) ‖}^{2}}{2 {σ}_{r}^{2}} )} \qquad ( 1 )$$

I(i, j) and I(k, l) are the intensity value of samples (i, j) and (k, l) respectively. σ_{d} is the spatial parameter, and σᵣ is the range parameter. The filtering process with the filtered sample value denoted by I_{D}(i, j) could be defined as:

$${I}_{D} ( i , j ) = \frac{{\sum }_{k , l} I ( k , l ) * ω ( i , j , k , l )}{{\sum }_{k , l} ω ( i , j , k , l )} \qquad ( 2 )$$

In the properties (or strength) of the bilateral filter are controlled by these two parameters. Samples located closer to the sample to be filtered, and samples having smaller intensity difference to the sample to be filtered, will have larger weight than samples further away and with larger intensity difference.

As described in Jacob Strom, Per Wennersten, Ying Wang, Kenneth Andersson, Jonatan Samuelsson, “Bilateral filter after inverse transform”, JVET-D0069, 4th Meeting: Chengdu, CN, 15-21 Oct. 2016, each reconstructed sample in the TU is filtered using its direct neighboring reconstructed samples only.

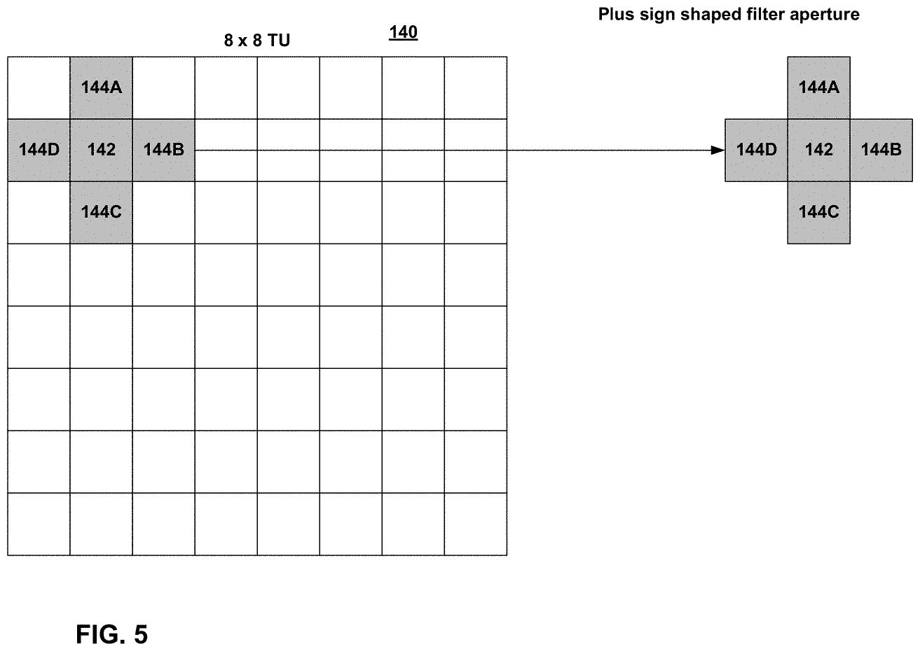

FIG. 5 shows an example of 8×8 TU 140. In TU 140, sample 142 has four neighboring samples 144A-144D utilized in bilateral filtering process. The filter has a “plus” (+) sign shaped filter aperture centered at the sample to be filtered (sample 142), as depicted in FIG. 5. σ_{d} to be set based on the transform unit size (3), and σᵣ to be set based on the QP used for the current block (4).

$$\begin{matrix}{σ}_{d} = 0.92 - \frac{min ( 16 , min ( TU block width , TU block height ) )}{40} & ( 3 ) \\ {σ}_{r} = max ( \frac{( QP - 17 )}{2} , 0.01 ) & ( 4 )\end{matrix}$$

As described in J. Strom, P. Wennersten, K. Andersson, J. Enhorn, “Bilateral filter strength based on prediction mode”, JVET-E0032, 5th Meeting: Geneva, CH, 12-20 Jan. 2017, to further reduce the coding loss under low delay configuration, the filter strength is designed to be dependent on the coded mode. For intra-coded blocks, the above equation (3) is still used. While for inter-coded blocks, the following equation is applied:

$${σ}_{d} = 0.72 - \frac{min ( 8 , min ( TU block width , TU block height ) )}{40} \qquad ( 5 )$$

The different values for σ_{d} means that filter strength for inter prediction blocks is relatively weaker compared to that of intra prediction blocks. Inter predicted blocks typically have less residual than intra predicted blocks and therefore the bilateral filter is designed to filter the reconstruction of inter predicted blocks less.

The output filtered sample value I_{D}(i,j) is calculated as:

$${I}_{F} ( i , j ) = \frac{{\sum }_{k , l} I ( k , l ) * ω ( i , j , k , l )}{{\sum }_{k , l} ω ( i , j , k , l )} \qquad ( 6 )$$

Since the filter only touches the sample and its 4-neighbours, the above equation can be written as

$${I}_{F} = \frac{{I}_{C} {ω}_{C} + {I}_{L} {ω}_{L} + {I}_{R} {ω}_{R} + {I}_{A} {ω}_{A} + {I}_{B} {ω}_{B}}{{ω}_{C} + {ω}_{L} + {ω}_{R} + {ω}_{A} + {ω}_{B}} \qquad ( 7 )$$

where I_{C} is the intensity of the center sample, and I_{L}, I_{R}, I_{A} and I_{B} are the intensities for the left, right, above and below samples, respectively. Likewise, ω_{C} is the weight for the center sample, and ω_{L}, ω_{R}, ω_{A} and ω_{B} are the corresponding weights for the neighbouring samples. The filter only uses samples within the block for filtering—weights outside are set to 0.

In order to reduce the number of calculations, the bilateral filter in the JEM has been implemented using a look-up-table (LUT). For every QP, there is a one-dimensional LUT for the values ω_{L}, ω_{R}, ω_{A} and ω_{B} where the value

$${ω}_{other} = round ( 65 * {e}^{( - \frac{1}{2 * {0.82}^{2}} - \frac{{‖ I - {I}_{C} ‖}^{2}}{2 {σ}_{r}^{2}} )} ) \qquad ( 8 )$$

is stored, where αᵣ² is calculated from (4) depending upon QP. Since σ_{d}=0.92−4/40=0.82 in the LUT, it can be used directly for the intra M×N block with min(M, N) equal to 4 with a center weight ω_{C} of 65, which represents 1.0. For the other modes (i.e., intra M×N but min(M, N) not equal to 4, inter K×L blocks), the same LUT is used, but instead use a center weight is scaled as follows:

$${ω}_{C} = round ( 65 * \frac{{e}^{- \frac{1}{2 * {0.82}^{2}}}}{{e}^{- \frac{1}{2 * {σ}_{d}^{2}}}} ) , \qquad ( 9 )$$

where σₐ is obtained by (3) or (5). The final filtered value is calculated as

$${I}_{F} = floor ( \frac{\begin{matrix}{I}_{C} {ω}_{C} + {I}_{L} {ω}_{L} + {I}_{R} {ω}_{R} + {I}_{A} {ω}_{A} + {I}_{B} {ω}_{B} + \\ ( ( {ω}_{C} + {ω}_{L} + {ω}_{R} + {ω}_{A} + {ω}_{B} ) 1\end{matrix}}{{ω}_{C} + {ω}_{L} + {ω}_{R} + {ω}_{A} + {ω}_{B}} ) \qquad ( 10 )$$

where the division used is integer division and the term (σ_{C}+ω_{L}+ω_{R}+ω_{A}+ω_{B})>>1 is added to get correct rounding.

In the JEM reference software, the division operation in Equation (10) is replaced by an LUT, multiplication and shift operations. To reduce the size of the numerator and denominator, Equation (10) is further simplified as

$${I}_{F} = {I}_{C} + \frac{{ω}_{L} ( {I}_{L} - {I}_{C} ) + {ω}_{R} ( {I}_{R} - {I}_{C} ) + {ω}_{A} ( {I}_{A} - {I}_{C} ) + {ω}_{B} ( {I}_{B} - {I}_{C} )}{{ω}_{C} + {ω}_{L} + {ω}_{R} + {ω}_{A} + {ω}_{B}} \qquad ( 11 )$$

In the JEM reference software, Equation (11) is implemented in a way that the division could be implemented by two look-up tables as follows:

I_{F}=I_{C}+s*((s*a+((b+m)>>1))*divOneOverN[b]>>(14+divShift[b]))

a=(ω_{L}(I_{L}−I_{C})+ω_{R}(I_{R}−I_{C})+ω_{A}(I_{A}−I_{C})+ω_{B}(I_{B}−I_{C})

b=ω_{C}+ω_{L}+ω_{R}+ω_{A}+ω_{B}

m=(a<0)?−1:0

s=sgn(a)=(a<0)?−1:1 (12)

The two look-up tables are the look-up table divOneOverN to get an approximated value for each 1/x (x is a positive integer value) after shifting, and a look-up table divShift to define the additional shift value for input x. J. Strom, P. Wennersten, K. Andersson, J. Enhorn, “EE2-JVET related: Division-free bilateral filter,” JVET-F0096, 6th Meeting: Hobart, CH, 31 Mar.-7 Apr. 2017 describes more details on this concept.

The filter is turned off if QP<18 or if the block is of inter type and the block dimensions are 16×16 or larger. It is also noted that the proposed bilateral filtering method is only applied to luma blocks with at least one non-zero coefficients. For chroma blocks and luma blocks with all zero coefficients, the bilateral filtering method may always be disabled.

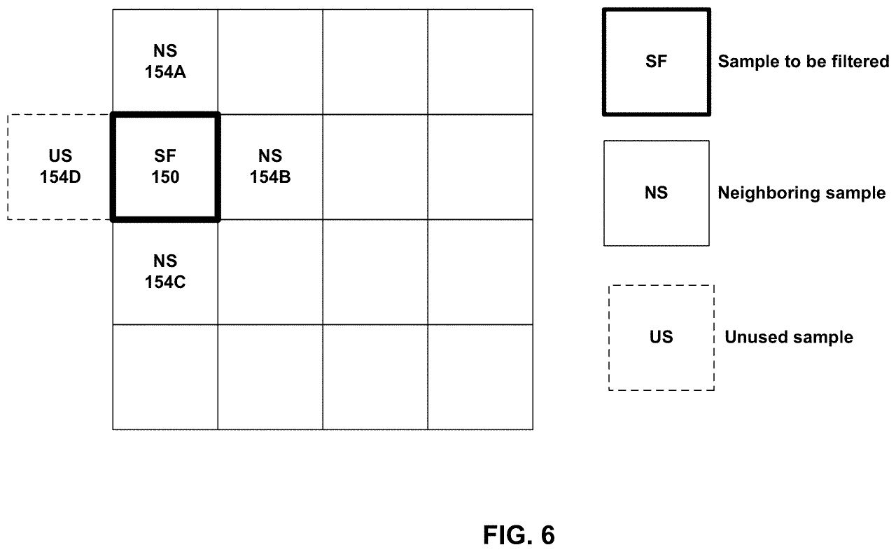

FIG. 6 shows an example of a sample to be filtered 150 and its four neighboring samples 154A-154D utilized in a bilateral filtering process. For samples located at the top and left boundaries of a TU (i.e., top row and left column), only neighboring samples within the current TU are used to filter current sample, as shown in the example of FIG. 6. In the example of FIG. 6, samples 154A-154C may be used for filtering, while sample 154D may not be used.

U.S. Patent Publication 2019/0014349 A1 describes a division-free bilateral filtering (DFBil) that for one sample to be filtered, the filtering process could be defined as:

$${I}_{F} = {I}_{C} + {\sum }_{p = 1}^{N} {W}_{p} * ( {I}_{p} - {I}_{c} )$$

where I_{C} is the intensity of the current sample and I_{F} is the modified intensity of the current sample after performing DFBil, Iₚ and Wₚ are the intensity and weighting parameter for the p-th neighboring sample, respectively.

$${w}_{p} = {Dis}_{p} * {Rang}_{p}$$

$${Rang}_{p} = {e}^{( - \frac{{‖ {I}_{p} - {I}_{c} ‖}^{2}}{2 {σ}_{r}^{2}} )}$$

$${Dis}_{p} = \frac{Temp {D}_{p}}{1 + {\sum }_{q = 1}^{N} Temp {D}_{q}}$$

$$Temp {D}_{p} = {e}^{( - \frac{{10}^{4} * sqrt ( {( i - k )}^{2} + {( j - l )}^{2} )}{2 {σ}_{d}^{2}} )}$$

$${σ}_{r} = {( QP - minDFBilQP + {2}^{*} {Index}_{r} )}^{*} 2$$

$${σ}_{d} = DCandidateList [ {Index}_{d} ]$$

where minDFBilQP indicates the minimum QP for which DFBil is applied (it is set to 17). Index_{d} and Indexᵣ may be signaled per quad-tree partition or selected based the size and/or mode of the block.

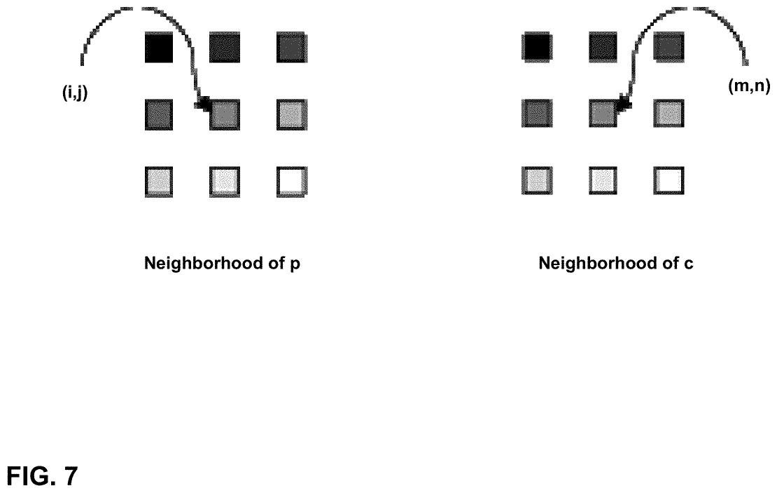

U.S. Patent Publication 2019/0082176 A1 describes a non-local division-free bilateral filter (NLBF). NLBF extends the DFBil proposed in US Patent Publication 2019/0014349 A1 as follows. The Rangₚ part of the filter weight in DFBil uses only the intensity difference between the pixel to be filtered and the neighboring pixel (to the left, right, below and above). It may lead to bad weights if the reconstructed pixel value is an outlier (very different from original pixel value). Considering the neighborhood of pixels (instead of only one pixel value) may ameliorate this problem. For pixels on TU boundary, DFBil only uses the neighboring pixels within the current TU. This may reduce the coding gains since the pixels outside of the TU are not considered in the weighted average while filtering boundary pixels. NLBF addresses these problems by changing the Rangₚ part of the filter weight as follows:

$${Rang}_{p} = exp ( - \frac{{‖ Δ {I}_{p , c} ‖}^{2}}{2 {σ}_{r}^{2}} ) ,$$

where ΔI_{p,c} is the sum of absolute differences between each corresponding pixel in a 3×3 window around pixel p and c (see FIG. 7). Let (i,j) be the coordinate of p and (m,n) be coordinate of c then

$$Δ {I}_{p , c} = {\sum }_{y = - 1}^{1} {\sum }_{x = - 1}^{1} \vert I ( i - x , j - y ) - I ( m - x , n - y ) \vert .$$

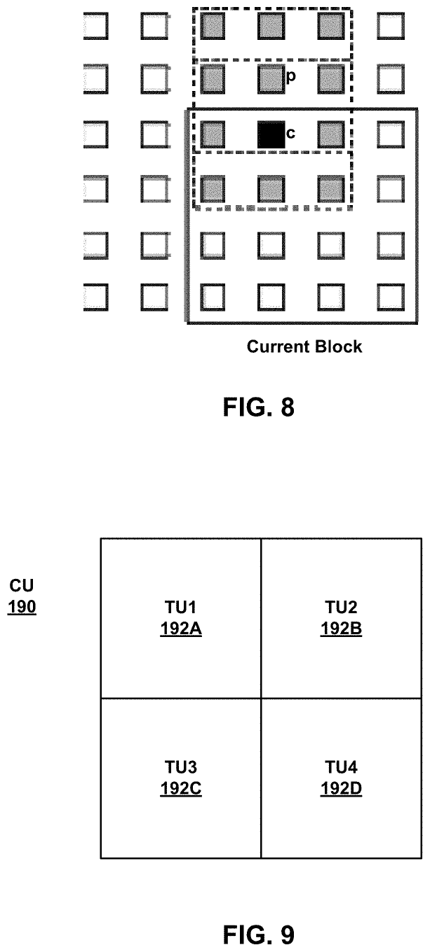

As shown in FIG. 7, NLBF takes a sum of absolute difference between each corresponding pixel in a 3×3 window around pixel p (neighbor) and pixel c (pixel to be filtered). NLBF is only used for inter-coded blocks for which two rows of pixels above the current block and to the left of the current block are already reconstructed (see FIG. 7). This is because while filtering the pixels on the left and above boundary of the current block with NLBF, the pixel values in those rows and columns are needed to compute ΔI_{p,c} as shown in FIG. 8. Using the pixels outside of the current block allows NLBF to better filter the pixels on the top and left boundary of the current block, which in turn leads to better coding gains. As shown in FIG. 8, NLBF uses reconstructed pixels from neighboring blocks while filtering boundary pixels. For example, while filtering pixel c NLBF uses the gray pixels in dotted blocks to compute ΔI_{p,c}.

The design of bilateral filter in JEM and NLBF in US Patent Publication US 2019/0082176 A1 may have some problems. As one example of a potential problem, NLBF may use (e.g., require) pixels outside the TU to be filtered. This introduces interdependencies in the processing of TUs. Consider a case, where a CU is further split into TUs. An example is shown in FIG. 9, where CU 190 is divided into 4 TUs (192A-192D). In order to apply NLBF to TU4 192D, the decoder needs reconstructed pixels from TUs 1, 2 and 3. In such an example, application of NLBF to TU 4 requires that the TUs 1, 2 and 3 are already reconstructed since reconstructed pixels from those TUs are used in the filtering boundary pixels in TU4 192D. Therefore, filtering of TU4 192D has to be postponed until the rest of TUs, e.g., 192A-192C, are reconstructed. This prevents parallelization of TU processing (inverse quantization, transform and reconstruction). As another example of a potential problem, the current bilateral filter is applied for a TU only if the corresponding CBF flag is true (i.e., prediction residual is non-zero). However, other block related information may be useful in deciding if bilateral filter should be applied.

To address the problems introduced above, this disclosure proposes several techniques described below. The various techniques described herein may be applied either individually or in any combination. The techniques described may not only be applied for non-local bilateral filtering, but also for any other filter that uses pixels from neighboring blocks to filter pixels in the current block. These techniques will be described with respect to video decoder 30, but it should be understood that unless stated to the contrary, these techniques may also be performed by video encoder 20. For example, video encoder 20 may decode video data as part of a video encoding process.

According to one technique of this disclosure, video decoder 30 may be configured to filter pixels in the current sub-block with a filter that uses pixels from neighboring sub-blocks only if the size of sub-block to be filtered equals the size of the block that contains it (i.e., there is only one sub-block in the block). In one example, video decoder 30 may be configured to apply the filter on a sub-block by sub-block basis within a block. Video decoder 30 may be configured to use pixels within a window around each pixel, such as a (2k+1)*(2k+1) window, to filter that pixel. In one example, the sub-block can be a TU and the block can be a CU containing the TU. In one example, the filter being used can be the NLBF that uses a 3×3 window surrounding each pixel applied to a TU. Therefore, the filter needs two rows and two columns from a TU to the top of current TU and a TU to the left of current TU, respectively to filter pixels on the top and left boundary of current TU. Non-local bilateral filter will be used to filter a TU only if the corresponding CU is not further split into smaller TUs. In one example, filtering of TUs can be postponed until after all TUs in a CU are reconstructed. NLBF can then be applied to all the pixels in the CU.

According to another technique of this disclosure, video decoder 30 may be configured to replace a filter that uses pixels outside the sub-block to be filtered by a filter that only uses the pixels in a given sub-block if pixels outside the sub-block to be filtered are not available. In one example, the filter that uses pixels within a (2k+1)*(2k+1) window around each pixel and is applied on a sub-block by sub-block basis within a block can be replaced by another filter that does not use pixels outside the sub-block to filter the whole sub-block. In another example, the replacement filter can be used to filter only the boundary pixels in the sub-block that use or require outside pixels for filtering. In one example, a sub-block can be a TU and the block can be the corresponding CU. The DFBil method may be used to filter a TU if the size of the TU is less than the size of the CU that contains the TU. In one example, the DFBil method may be used to filter the pixels in the left-most two columns and top-most two rows of a TU if the size of the TU is less than the size of the CU that contains the TU. The rest of the pixels in the TU can be filtered using the NLBF. In one example, a TU to be filtered may be padded with two additional rows by copying the pixels in the top-most row of the TU and then with two additional columns by copying the pixels in the left-most column. NLBF can then be used to filter all the pixels in the original TU to be filtered.

According to another technique of this disclosure, video decoder 30 may be configured to use additional block information such as prediction mode and the magnitude of prediction residual to decide if a bilateral filter is applied to that block or which type of bilateral filter is applied to that block. In one example, the bilateral filter may not be applied to a CU if the CU uses skip mode. The type of bilateral filter used may depend on the CU mode. For example, if the CU uses skip mode, then DFBil may be used to filter that CU and NLBF may be used otherwise. Bilateral filter may not be applied to a CU if magnitude of prediction residual for that CU is less than a certain pre-defined threshold. The type of bilateral filter used to filter a CU may depend on the magnitude of prediction residual for that CU. For example, if magnitude of prediction residual is less than a certain pre-defined threshold, then DFBil may be used to filter the CU and NLBF may be used otherwise.

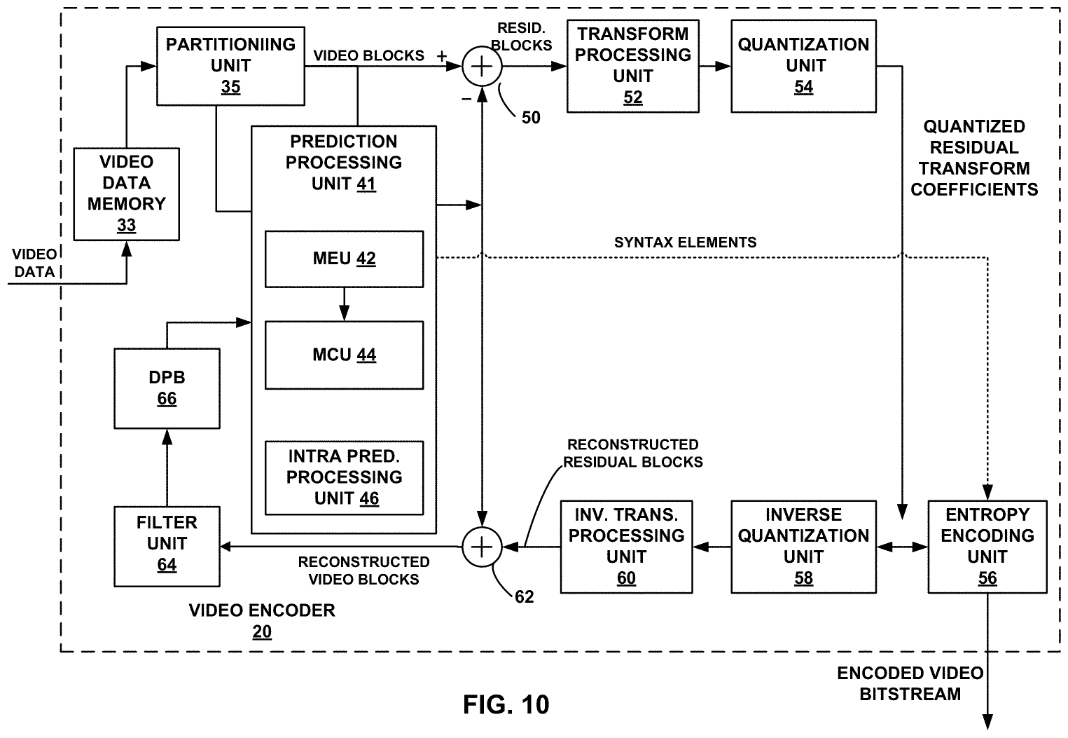

FIG. 10 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 10, video encoder 20 includes various circuitry such as programmable circuitry and/or fixed-function circuitry. The example operations of video encoder 20 may be performed by the programmable circuitry, fixed-function circuitry, or a combination. The units illustrated in FIG. 10 may be individual circuits or a combination of the units may form a circuit.

Video encoder 20 includes a video data memory 33, partitioning unit 35, prediction processing unit 41, summer 50, transform processing unit 52, quantization unit 54, entropy encoding unit 56. Prediction processing unit 41 includes motion estimation unit (MEU) 42, motion compensation unit (MCU) 44, and intra prediction unit 46. For video block reconstruction, video encoder 20 also includes inverse quantization unit 58, inverse transform processing unit 60, summer 62, filter unit 64, and decoded picture buffer (DPB) 66.

As shown in FIG. 10, video encoder 20 receives video data and stores the received video data in video data memory 33. Video data memory 33 may store video data to be encoded by the components of video encoder 20. The video data stored in video data memory 33 may be obtained, for example, from video source 18. DPB 66 may be a reference picture memory that stores reference video data for use in encoding video data by video encoder 20, e.g., in intra- or inter-coding modes. Video data memory 33 and DPB 66 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and DPB 66 may be provided by the same memory device or separate memory devices. In various examples, video data memory 33 may be on-chip with other components of video encoder 20, or off-chip relative to those components.

Partitioning unit 35 retrieves the video data from video data memory 33 and partitions the video data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 66. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 66. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

After prediction processing unit 41 generates the predictive block for the current video block, either via intra prediction or inter prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. In another example, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed block.

Filter unit 64 filters the reconstructed block (e.g. the output of summer 62) and stores the filtered reconstructed block in DPB 66 for use as a reference block. The reference block may be used by motion estimation unit 42 and motion compensation unit 44 as a reference block to inter-predict a block in a subsequent video frame or picture. Filter unit 64 may perform any type of filtering such as deblock filtering, SAO filtering, peak SAO filtering, ALF, and/or GALF, and/or other types of loop filters, including the techniques described in this disclosure. A deblock filter may, for example, apply deblocking filtering to filter block boundaries to remove blockiness artifacts from reconstructed video. A peak SAO filter may apply offsets to reconstructed pixel values in order to improve overall coding quality. Additional loop filters (in loop or post loop) may also be used.

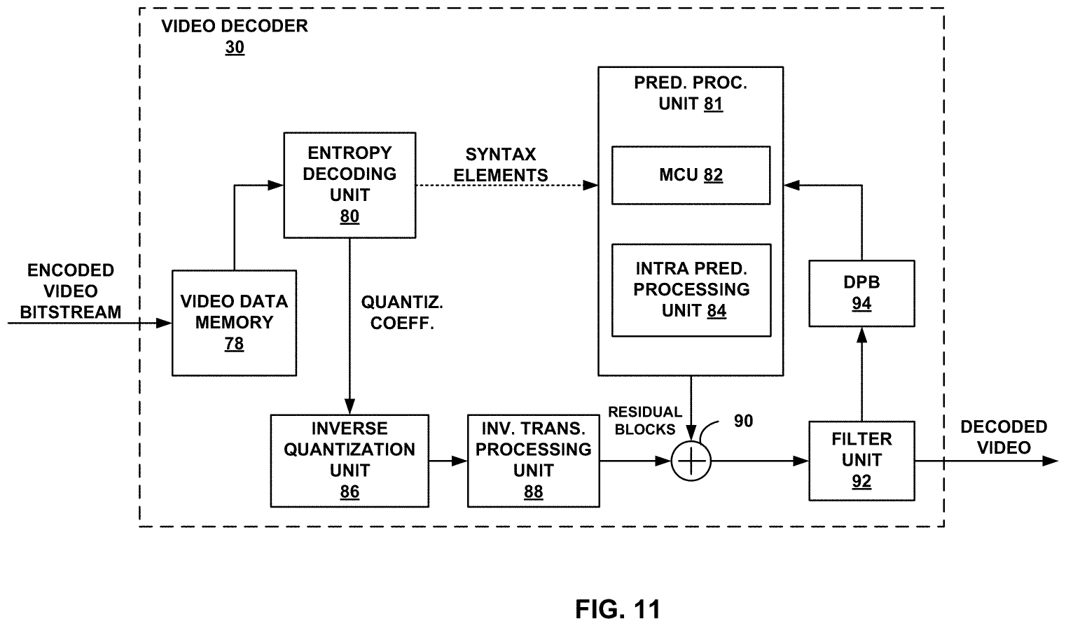

FIG. 11 is a block diagram illustrating an example video decoder 30 that may implement the techniques described in this disclosure. Video decoder 30 of FIG. 11 may, for example, be configured to receive the signaling described above with respect to video encoder 20 of FIG. 10. In the example of FIG. 11, video decoder 30 includes various circuitry such as programmable circuitry and/or fixed-function circuitry. The example operations of video encoder 20 may be performed by the programmable circuitry, fixed-function circuitry, or a combination. The units illustrated in FIG. 11 may be individual circuits or a combination of the units may form a circuit.

In the example of FIG. 11, video decoder 30 includes video data memory 78, entropy decoding unit 80, prediction processing unit 81, inverse quantization unit 86, inverse transform processing unit 88, summer 90, and DPB 94. Prediction processing unit 81 includes motion compensation unit 82 and intra prediction unit 84. Video decoder 30 may, in some examples, perform a decoding pass generally reciprocal to the encoding pass described with respect to video encoder 20 from FIG. 10.

During the decoding process, video decoder 30 receives an encoded video bitstream that represents video blocks of an encoded video slice and associated syntax elements from video encoder 20. Video decoder 30 stores the received encoded video bitstream in video data memory 78. Video data memory 78 may store video data, such as an encoded video bitstream, to be decoded by the components of video decoder 30. The video data stored in video data memory 78 may be obtained, for example, via link 16, from storage device 26, or from a local video source, such as a camera, or by accessing physical data storage media.

Video data memory 78 may form a coded picture buffer (CPB) that stores encoded video data from an encoded video bitstream. DPB 94 may be a reference picture memory that stores reference video data for use in decoding video data by video decoder 30, e.g., in intra- or inter-coding modes. Video data memory 78 and DPB 94 may be formed by any of a variety of memory devices, such as DRAM, SDRAM, MRAM, RRAM, or other types of memory devices. Video data memory 78 and DPB 94 may be provided by the same memory device or separate memory devices. In various examples, video data memory 78 may be on-chip with other components of video decoder 30, or off-chip relative to those components.

Entropy decoding unit 80 of video decoder 30 entropy decodes the video data stored in video data memory 78 to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction unit 84 of prediction processing unit 81 may generate prediction data for a video block of the current video slice based on a signaled intra prediction mode and data from previously decoded blocks of the current frame or picture. When the video frame is coded as an inter-coded slice (e.g., B slice or P slice), motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in DPB 94.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After prediction processing unit generates the predictive block for the current video block using, for example, intra or inter prediction, video decoder 30 forms a reconstructed video block by summing the residual blocks from inverse transform processing unit 88 with the corresponding predictive blocks generated by motion compensation unit 82. Summer 90 represents the component or components that perform this summation operation.

Filter unit 92 filters the reconstructed block (e.g. the output of summer 90) and stores the filtered reconstructed block in DPB 94 for uses as a reference block. The reference block may be used by motion compensation unit 82 as a reference block to inter-predict a block in a subsequent video frame or picture. Filter unit 92 may perform any type of filtering such as deblock filtering, SAO filtering, SAO filtering, ALF, and/or GALF, bilateral filtering, and/or other types of loop filters, including the techniques described in this disclosure. A deblock filter may, for example, apply deblocking filtering to filter block boundaries to remove blockiness artifacts from reconstructed video. An SAO filter may apply offsets to reconstructed pixel values in order to improve overall coding quality. Additional loop filters (in loop or post loop) may also be used.

The decoded video blocks in a given frame or picture are then stored in DPB 94, which stores reference pictures used for subsequent motion compensation. DPB 94 may be part of or separate from additional memory that stores decoded video for later presentation on a display device, such as display device 32 of FIG. 1.

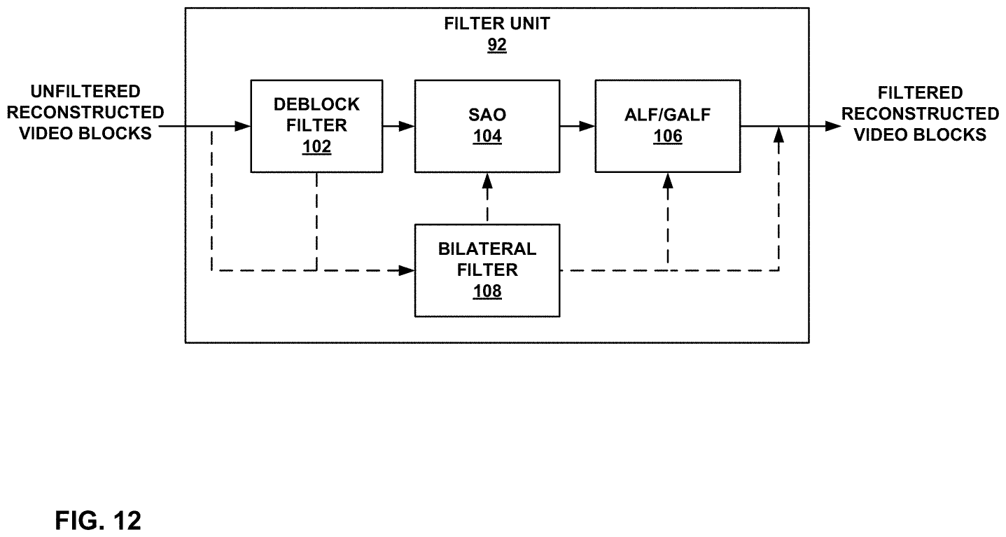

FIG. 12 shows an example implementation of filter unit 92. Filter unit 64 may be implemented in the same manner. Filter units 64 and 92 may perform the techniques of this disclosure, possibly in conjunction with other components of video encoder 20 or video decoder 30. In the example of FIG. 12, filter unit 92 includes deblock filter 102, SAO filter 104, and ALF/GLAF filter 106, as implemented in JEM 6 or 7. Filter unit 92 also includes bilateral filter 108. As shown in the example of FIG. 12, bilateral filter 108 may be used either separately from deblock filter 102, SAO filter 104, and/or ALF/GLAF filter 106, or in conjunction with deblock filter 102, SAO filter 104, and/or ALF/GLAF filter 106. In alternate implementations, filter unit 92 may include fewer filters and/or may include additional filters than those shown in FIG. 12. Additionally or alternatively, the particular filters shown in FIG. 12 may be implemented in a different order than shown in FIG. 12.

In FIG. 12, the dashed lines are used to indicate optional interconnections of the filter blocks. For instance, bilateral filter 108 may receive unfiltered reconstructed video blocks and/or the output of deblock filter 102. Bilateral filter 108 may output to SAO 104 an/or ALF/GALF 106, and/or may generate the filtered reconstructed video blocks.

Filter unit 92 may be configured to perform various techniques described in this disclosure. For example, for a first block of video data, filter unit 92 may be configured to determine that a filter process using a first filter for a sub-block of the first block uses pixel values from neighboring sub-blocks of the sub-block of the first block; determine a number of sub-blocks in the first block of video data; and in response to the number of sub-blocks in the first block video data being equal to one, filter the sub-block using the first filter. For a second block of video data, filter unit 92 may be configured to determine that the filter process using the first filter for a sub-block of the second block uses pixel values from neighboring sub-blocks of the sub-block of the second block; determine a number of sub-blocks in the second block of video data; and in response to the number of sub-blocks in the second block video data being greater than one, not filtering the sub-block of the second block with the first filter and/or filtering the sub-block of the second block with a filter different than the first filter.

In other examples, for a first block of video data, filter unit 92 may be configured to determine that a filter process using a first filter for a sub-block of the first block uses pixel values from neighboring sub-blocks of the sub-block of the first block; determine that the used pixel values from the neighboring sub-blocks of the sub-block of the first block are unavailable; and, in response to the used pixel values from the neighboring sub-blocks of the sub-block of the first block are unavailable, filter the sub-block of the first block with a filter different than the first filter. To filter the sub-block of the first block with the filter different than the first filter, filter unit 92 may be configured to filter all pixels of the sub-block of the first block with the filter different than the first filter. To filter the sub-block of the first block with the filter different than the first filter, filter unit 92 may be configured to filter some pixels of the sub-block of the first block with the filter different than the first filter and other pixels of the sub-block of the first block with the first filter. The first filter may, for example, be an NLBF, and the filter different than the first filter may be a DFBil.

In other example, filter unit 92 may, for a first block of video data, be configured to determining that a filter process using a first filter for a sub-block of the first block uses pixel values from neighboring sub-blocks of the sub-block of the first block; determine that the used pixel values from the neighboring sub-blocks of the sub-block of the first block are unavailable; in response to the used pixel values from the neighboring sub-blocks of the sub-block of the first block being unavailable, copy pixels in the sub-block to determine padded values for the used pixel values; and filter the sub-block of the first block with the first filter.

In other example, filter unit 92 may be configured to determine block information for a first block of video data and select a type of filter for the first block based on the block information. The block information may, for example, include the block being coded in a skip mode, and the type of filter comprises not applying a bi-lateral filter.

To determine the block information for the first block of video data, filter unit 92 may be configured to determine a coding mode for the block select the type of filter for the first block based on the block information by selecting a DFBil filter if the coding mode is a skip mode and selecting an NLBF filter if the coding mode is other than the skip mode. To determine the block information for the first block of video data, filter unit 92 may be configured to determine a magnitude of prediction residual for the block select the type of filter for the first block based on the block information by not applying bi-lateral filtering in response to the magnitude of the prediction residual being less than a threshold. To determine the block information for the first block of video data, filter unit 92 may be configured to determine a magnitude of prediction residual for the block and select the type of filter for the first block based on the block information by applying DFBil filtering in response to the magnitude of the prediction residual being less than a threshold. To determine the block information for the first block of video data, filter unit 92 may be configured to determine a magnitude of prediction residual for the block select the type of filter for the first block based on the block information by applying NLBF filtering in response to the magnitude of the prediction residual being greater than a threshold.

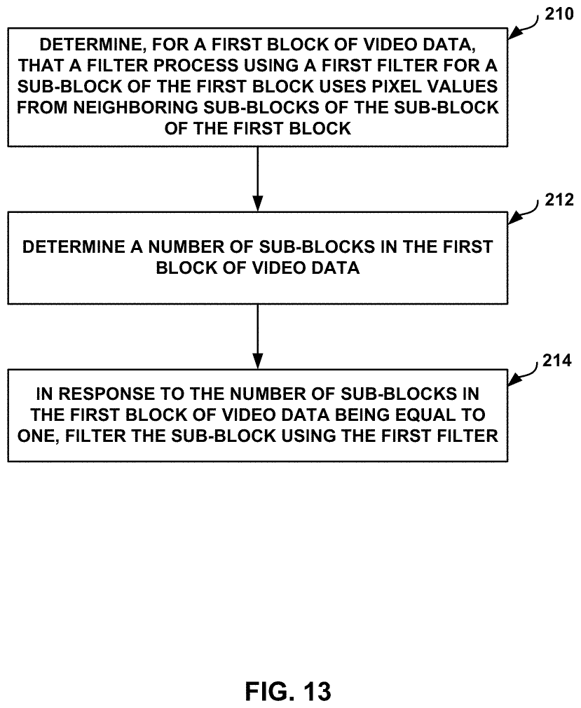

FIG. 13 is a flowchart illustrating an example decoding process of this disclosure. The techniques of FIG. 13 may be performed by one or more structural units of video encoder 20 and video decoder 30, including filter unit 64 and filter unit 92. Although the techniques of FIG. 13 will be described with reference to a video decoder, the techniques may be performed as part of a video encoding process, for example by the decoding loop of video encoder 20.

In the example of FIG. 13, the video decoder determines, for a first block of video data, that a filter process using a first filter for a sub-block of the first block uses pixel values from neighboring sub-blocks of the sub-block of the first block (210). The video decoder determines a number of sub-blocks in the first block of video data (212). In response to the number of sub-blocks in the first block of video data being equal to one, the video decoder filters the sub-block using the first filter (214). The first block of video data may, for example, correspond to a first CU, and the sub-block of the first block may correspond to a TU of the first CU.

The video decoder may also be configured to determine, for a second block of video data, that the filter process using the first filter for a sub-block of the second block uses pixel values from neighboring sub-blocks of the sub-block of the second block; determine a number of sub-blocks in the second block of video data; and in response to the number of sub-blocks in the second block video data being greater than one, do at least one of: (1) not filter the sub-block of the second block with the first filter or (2) filter the sub-block of the second block with a filter different than the first filter. The first filter may, for example, use pixels in a window around a pixel being filtered. The first filter may, for example, be an NLBF, and the filter different than the first filter may be a DFBil.

The video decoder may filter the sub-block using the first filter further in response to determining that the used pixel values from the neighboring sub-blocks of the sub-block of the first block are available. The video decoder may for a second block of video data, determine that the filter process using the first filter for a sub-block of the second block uses pixel values from neighboring sub-blocks of the sub-block of the second block; determine that the used pixel values from the neighboring sub-blocks of the sub-block of the second block are unavailable; and in response to the used pixel values from the neighboring sub-blocks of the sub-block of the second block being unavailable, filter the sub-block of the second block with a filter different than the first filter. To filter the sub-block of the second block with the filter different than the first filter, the video decoder may be configured to filter all pixels of the sub-block of the second block with the filter different than the first filter.

To filter the sub-block of the second block with the filter different than the first filter, the video decoder may be configured to filter some pixels of the sub-block of the second block with the first filter and other pixels of the sub-block of the second block with the filter different than the first filter. The other pixels may be boundary pixels. The filter different than the first filter may only use pixels values in the sub-block of the first block. The video decoder may be configured to determine, for a second block of video data, that the filter process using the first filter for a sub-block of the second block uses pixel values from neighboring sub-blocks of the sub-block of the second block; determine that the pixel values from the neighboring sub-blocks of the sub-block of the second block are unavailable; pad the unavailable pixel values from the neighboring sub-blocks with pixel values from the second block; and filter the sub-block of the second block using the first filter.

The video decoder may be configured to determine block information for the first block of video data and, based on the block information, determine that the filter process is enabled for the first block. The block information may, for example, be one or more of a prediction mode for the block or a magnitude of prediction residual for the first block.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
for a first block of video data, determining that a filter process using a first filter for a sub-block of the first block uses pixel values from neighboring sub-blocks of the sub-block of the first block;
determining a number of sub-blocks in the first block of video data; and
in response to the number of sub-blocks in the first block of video data being equal to one, filtering the sub-block using the first filter.

2. The method of claim 1, wherein the first block of video data corresponds to a first coding unit (CU), and the sub-block of the first block corresponds to a transform unit (TU) of the first CU.

3. The method of claim 1, further comprising:
for a second block of video data, determining that the filter process using the first filter for a sub-block of the second block uses pixel values from neighboring sub-blocks of the sub-block of the second block;
determining a number of sub-blocks in the second block of video data; and
in response to the number of sub-blocks in the second block video data being greater than one, doing at least one of: (1) not filtering the sub-block of the second block with the first filter or (2) filtering the sub-block of the second block with a filter different than the first filter.

4. The method of claim 1, wherein the first filter uses pixels in a window around a pixel being filtered.

5. The method of claim 1, wherein the first filter comprises a non-local division-free bilateral filter (NLBF) and the filter different than the first filter comprises a division-free bilateral filter (DFBil).

6. The method of claim 1, wherein filtering the sub-block using the first filter is performed further in response to determining that the used pixel values from the neighboring sub-blocks of the sub-block of the first block are available.

7. The method of claim 6, further comprising:
for a second block of video data, determining that the filter process using the first filter for a sub-block of the second block uses pixel values from neighboring sub-blocks of the sub-block of the second block;
determining that the used pixel values from the neighboring sub-blocks of the sub-block of the second block are unavailable;
in response to the used pixel values from the neighboring sub-blocks of the sub-block of the second block being unavailable, filtering the sub-block of the second block with a filter different than the first filter.

8. The method of claim 7, wherein filtering the sub-block of the second block with the filter different than the first filter comprises filtering all pixels of the sub-block of the second block with the filter different than the first filter.

9. The method of claim 7, wherein filtering the sub-block of the second block with the filter different than the first filter comprises filtering some pixels of the sub-block of the second block with the first filter and other pixels of the sub-block of the second block with the filter different than the first filter.

10. The method of claim 9, wherein the other pixels comprise boundary pixels.

11. The method of claim 10, wherein the filter different than the first filter only uses pixels values in the sub-block of the first block.

12. The method of claim 1, further comprising:
for a second block of video data, determining that the filter process using the first filter for a sub-block of the second block uses pixel values from neighboring sub-blocks of the sub-block of the second block;
determining that the pixel values from the neighboring sub-blocks of the sub-block of the second block are unavailable;
padding the unavailable pixel values from the neighboring sub-blocks with pixel values from the second block; and
and filtering the sub-block of the second block using the first filter.

13. The method of claim 1, further comprising:
determining block information for the first block of video data; and
based on the block information, determining that the filter process is enabled for the first block.

14. The method of claim 13, wherein the block information comprises one or more of a prediction mode for the block or a magnitude of prediction residual for the first block.

15. A device for decoding video data, the device comprising:
a memory configured to store video data; and
one or more processors configured to:
for a first block of video data, determine that a filter process using a first filter for a sub-block of the first block uses pixel values from neighboring sub-blocks of the sub-block of the first block;
determine a number of sub-blocks in the first block of video data; and
in response to the number of sub-blocks in the first block of video data being equal to one, filter the sub-block using the first filter.

16. The device of claim 15, wherein the first block of video data corresponds to a first coding unit (CU), and the sub-block of the first block corresponds to a transform unit (TU) of the first CU.

17. The device of claim 15, wherein the one or more processors are further configured to:
for a second block of video data, determine that the filter process using the first filter for a sub-block of the second block uses pixel values from neighboring sub-blocks of the sub-block of the second block;
determine a number of sub-blocks in the second block of video data; and
in response to the number of sub-blocks in the second block video data being greater than one, do at least one of: (1) not filter the sub-block of the second block with the first filter or (2) filter the sub-block of the second block with a filter different than the first filter.

18. The device of claim 15, wherein the first filter uses pixels in a window around a pixel being filtered.

19. The device of claim 15, wherein the first filter comprises a non-local division-free bilateral filter (NLBF) and the filter different than the first filter comprises a division-free bilateral filter (DFBil).

20. The device of claim 15, wherein the one or more processors filter the sub-block using the first filter further in response to determining that the used pixel values from the neighboring sub-blocks of the sub-block of the first block are available.

21. The device of claim 20, wherein the one or more processors are further configured to:
for a second block of video data, determine that the filter process using the first filter for a sub-block of the second block uses pixel values from neighboring sub-blocks of the sub-block of the second block;
determine that the used pixel values from the neighboring sub-blocks of the sub-block of the second block are unavailable;
in response to the used pixel values from the neighboring sub-blocks of the sub-block of the second block being unavailable, filter the sub-block of the second block with a filter different than the first filter.

22. The device of claim 21, wherein to filter the sub-block of the second block with the filter different than the first filter, the one or more processors are further configured to filter all pixels of the sub-block of the second block with the filter different than the first filter.

23. The device of claim 21, wherein to filter the sub-block of the second block with the filter different than the first filter, the one or more processors are further configured to filter some pixels of the sub-block of the second block with the first filter and other pixels of the sub-block of the second block with the filter different than the first filter.

24. The device of claim 23, wherein the other pixels comprise boundary pixels.

25. The device of claim 24, wherein the filter different than the first filter only uses pixels values in the sub-block of the first block.

26. The device of claim 25, wherein the one or more processors are further configured to:
for a second block of video data, determine that the filter process using the first filter for a sub-block of the second block uses pixel values from neighboring sub-blocks of the sub-block of the second block;
determine that the pixel values from the neighboring sub-blocks of the sub-block of the second block are unavailable;
pad the unavailable pixel values from the neighboring sub-blocks with pixel values from the second block; and
filter the sub-block of the second block using the first filter.

27. The device of claim 15, wherein the one or more processors are further configured to:
determine block information for the first block of video data; and
based on the block information, determine that the filter process is enabled for the first block.

28. The device of claim 27, wherein the block information comprises one or more of a prediction mode for the block or a magnitude of prediction residual for the first block.

29. An apparatus comprising:
means for determining, for a first block of video data, that a filter process using a first filter for a sub-block of the first block uses pixel values from neighboring sub-blocks of the sub-block of the first block;
means for determining a number of sub-blocks in the first block of video data; and
means for filtering the sub-block using the first filter in response to the number of sub-blocks in the first block of video data being equal to one.

30. A computer-readable storage medium storing instructions that when executed by one or more processors cause the one or more processors to:
for a first block of video data, determine that a filter process using a first filter for a sub-block of the first block uses pixel values from neighboring sub-blocks of the sub-block of the first block;
determine a number of sub-blocks in the first block of video data; and
in response to the number of sub-blocks in the first block of video data being equal to one, filter the sub-block using the first filter.
